(19) United States
(12) Patent Application Publication
(10) Pub. No.: US 2019/0251936 A1
(43) Pub. Date: Aug. 15, 2019

(54) KEYBOARD INSTRUMENT

(71) Applicant: YAMAHA CORPORATION, Hamamatsu-shi (JP)

(72) Inventor: Masahiro HIRUMA, Hamamatsu-shi (JP)

(21) Appl. No.: 16/395,799

(22) Filed: Apr. 26, 2019

Related U.S. Application Data
(63) Continuation of application No. PCT/JP2017/040042, filed on Nov. 7, 2017.

(30) Foreign Application Priority Data
Nov. 10, 2016 (JP) 2016-219486

(51) Int. Cl. G10H 1/00; G10H 1/34

(52) U.S. Cl. CPC G10H 1/0008; G10H 2210/076; G10H 2220/221; G10H 1/344

(57) ABSTRACT

A keyboard instrument includes: a keyboard including keys; guide lamps for the respective keys; and a playing device that starts playing based on performance information in a first or second play start mode. In the first play start mode, a guide lamp farthest from the keyboard among the guide lamps for a key to be operated first is turned on at a first time point that is earlier than a timing at which a sound corresponding to the key to be operated first is output, and a guide lamp nearest to the keyboard is turned on at a second time point that is a timing at which the key to be operated first is to be pressed, and the sound is output at the second time point. In the second play start mode, the sound is output at the second time point.

### CROSS REFERENCE TO RELATED APPLICATION

The present application is a continuation application of International Application No. PCT/JP2017/040042, filed on Nov. 7, 2017, which claims priority to Japanese Patent Application No. 2016-219486, filed on Nov. 10, 2016. The contents of these applications are incorporated herein by in their entirety.

### BACKGROUND

The present disclosure relates to a keyboard instrument that provides an instruction for key pressing by means of a plurality of guide lamps.

There are conventionally proposed various techniques relating to a keyboard instrument that provides an instruction for key pressing by means of a plurality of guide lamps. For example, a playing assisting device disclosed in Patent Document 1 (Japanese Patent Application Publication No. 2000-214848) described below first indicates an image of a music by producing musical sounds as a model (model playing) and thereafter indicates a key-pressing position for a player performing playing with a keyboard, by means of an advance-indication LED and a key-pressing instructing LED corresponding to the key (playing guide). In the playing guide, the advance-indication LED is turned on in advance of a key pressing timing to indicate the key-pressing position in advance (advance indication). This enables the player to visually recognize which key is to be pressed next. At the key pressing timing, the key-pressing instructing LED is turned on to indicate the key-pressing position and the key pressing timing (key-pressing instruction). This enables the player to visually recognize a key to be pressed actually.

In the model playing and the playing guide, an advance-notice time set in advance for indicating the key to be operated first in playing is inserted in the beginning of the playing to ensure a time for the advance indication.

### SUMMARY

However, in the playing assisting device disclosed in Patent Document 1, for example, in the case where the player sets the playing assisting device such that model playing is to be performed without advance indication, even though the advance indication, i.e., the advance-notice time is not necessary, a musical sound corresponding to the key to be operated first in the playing is produced after the elapse of the advance-notice time from the beginning of the playing. Thus, a blank time in which turning on of the advance-indication LED and production of musical sound are not performed is generated in the beginning of the playing.

Accordingly, an aspect of the disclosure relates to a keyboard instrument having: a play start mode in which a time for a key-pressing advance notice is ensured at the start of playing based on performance information; and a play start mode in which the time for the key-pressing advance notice at the start of playing based on the performance information is removed.

In one aspect of the disclosure, a keyboard instrument comprises: a keyboard comprising a plurality of keys; a plurality of guide lamps provided corresponding respectively to the plurality of keys of the keyboard and arranged in a longitudinal direction of the plurality of keys; and a playing device configured to start playing based on performance information in a first play start mode or a second play start mode, wherein, in the first play start mode, in response to a playing instruction that is an instruction for playing based on the performance information, a guide lamp farthest from the keyboard among the plurality of guide lamps for a key to be operated first among the plurality of keys is turned on at a first time point that is earlier than a timing at which a sound corresponding to the key to be operated first is output, and a guide lamp nearest to the keyboard among the plurality of guide lamps is turned on at a second time point that is a timing at which the key to be operated first is to be pressed, and the sound corresponding to the key to be operated first is output at the second time point, and wherein, in the second play start mode, in response to the playing instruction, the sound corresponding to the key to be operated first is output at the second time point.

In one aspect of the disclosure, a keyboard instrument comprises: a keyboard comprising a plurality of keys; a plurality of guide lamps provided corresponding respectively to the plurality of keys of the keyboard and arranged in a longitudinal direction of the plurality of keys; and a playing device configured to start playing based on the performance information, wherein the playing device is configured to: when the predetermined condition is satisfied, in response to a playing instruction that is an instruction for playing based on the performance information, output a sound corresponding to a key to be operated first among the plurality of keys, at a time point at which a first period has elapsed from the playing instruction; and when the predetermined condition is not satisfied, in response to the playing instruction, turn on the plurality of guide lamps in order from a guide lamp farthest from the keyboard, to a guide lamp nearest to the keyboard among the plurality of guide lamps for the key to be operated first, and output the sound corresponding to the key to be operated first, at a time point at which a second period greater than the first period has elapsed from the playing instruction.

### BRIEF DESCRIPTION OF THE DRAWINGS

The objects, features, advantages, and technical and industrial significance of the present disclosure will be better understood by reading the following detailed description of the embodiment, when considered in connection with the accompanying drawings, in which:

FIG. 1 is a plan view of an electronic keyboard instrument according to an embodiment;

FIG. 2 is an enlarged view of guide indicators and a keyboard;

FIG. 3 is a block diagram illustrating an electric configuration of the electronic keyboard instrument;

FIG. 4 is a front elevational view of a button group;

FIG. 5 is a timing chart for explaining one example of blinking of the guide indicator;

FIG. 6 is a view for explaining one example of transition of illumination of the guide indicator;

FIG. 7 is a functional block diagram of the electronic keyboard instrument;

FIG. 8 is a timing chart for explaining a first play start mode;

FIG. 9 is a timing chart for explaining a second play start mode;

FIG. 10 is a timing chart for explaining the first play start mode;

FIG. 11 is a timing chart for explaining the second play start mode; and

FIG. 12 is a flowchart representing playing operations of the electronic keyboard instrument.

### EMBODIMENT

### Configuration of Keyboard Instrument

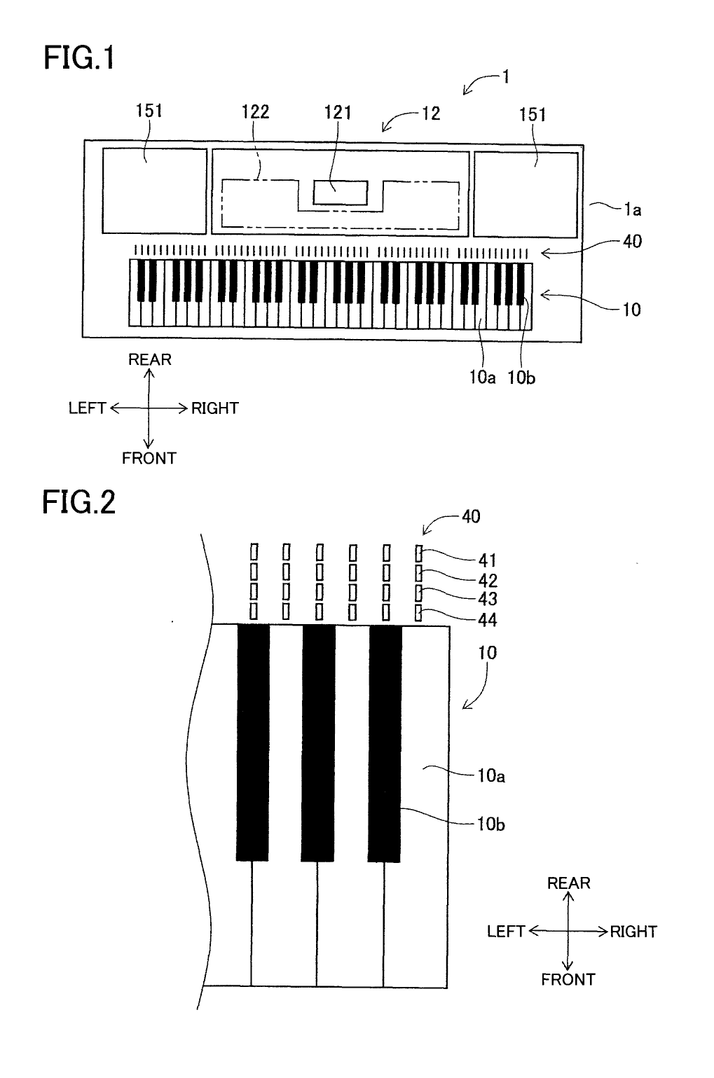

There will be described a configuration of an electronic keyboard instrument 1 having a lesson function (which will be described below) with reference to FIG. 1. The electronic keyboard instrument 1 includes a housing 1a, a keyboard 10, a user interface 12, and speakers 151, 151. The keyboard 10, the user interface 12, and the speakers 151, 151 are disposed at a front surface of the housing 1a. The keyboard 10 includes a plurality of white keys 10a and black keys 10b corresponding to pitches, respectively. In the following description, a direction in which the keys of the keyboard 10 are arranged will be referred to as “right and left direction”, and a direction orthogonal to the right and left direction in plan view will be referred to as “front and rear direction”. Thus, the longitudinal direction of the key of the keyboard 10 is parallel with the front and rear direction. The user interface 12 and the speakers 151, 151 are disposed at a rear portion of the keyboard 10. The speakers 151, 151 emit sounds such as a sound related to an operation performed on the keyboard 10 and an automatic playing sound based on music data (which will be described below). The user interface 12 includes: a liquid crystal display 121; guide indicators 40 equal in number to the keys of the keyboard 10; and a button group 122. The liquid crystal display 121 is disposed at a substantially center of the user interface 12 in the right and left direction to display information such as a setting screen. Each of the guide indicators 40 corresponds to one of the keys of the keyboard 10 and is disposed near the key. The button group 122 is disposed on right, left, and front sides of the liquid crystal display 121 and includes a plurality of operation buttons such as a power button, not illustrated. In FIGS. 1 and 2, reference numerals are assigned to only ones of the white keys 10a, the black keys 10b, and the guide indicators 40.

The guide indicators 40 will be explained in detail with reference to FIG. 2. Each of the guide indicators 40 includes first to third advance lights 41-43 and a key-pressing instructing light 44 corresponding to one of the keys. A portion of the housing 1a has rectangular transmissive sheets corresponding respectively to the first to third advance lights 41-43 and the key-pressing instructing light 44. Four LEDs (Light Emitting Diodes), not illustrated, are disposed in the housing 1a at the respective transmissive sheets as indicator lights. Each of the transmissive sheets is a sheet through which light can pass. The color of light emitted from each LED is red, for example. In the case where the LED illuminates, a user can visually recognize the light emitted from the LED and having passed through the transmissive sheet. Here, the configurations each including the transmissive sheet and the LED are respectively referred to as the first to third advance lights 41-43 and the key-pressing instructing light 44. It is noted that the distance between the first advance light 41 and the key corresponding to the guide indicator 40 including the first advance light 41 is the largest. The distance between the key-pressing instructing light 44 and the key corresponding to the guide indicator 40 including the key-pressing instructing light 44 is the smallest.

Each of the first to third advance lights 41-43 is turned on in advance of a key pressing timing at which the user should press the key, to notify the user of the key pressing timing in advance (noted that this notice will be hereinafter referred to as “key-pressing advance notice”). The key-pressing instructing light 44 is turned on at the key pressing timing to indicate the key pressing timing (noted that this indication will be hereinafter referred to as “key-pressing instruction”). The respective transmissive sheets of the first to third advance lights 41-43 and the key-pressing instructing light 44 have the same rectangular shape in plan view.

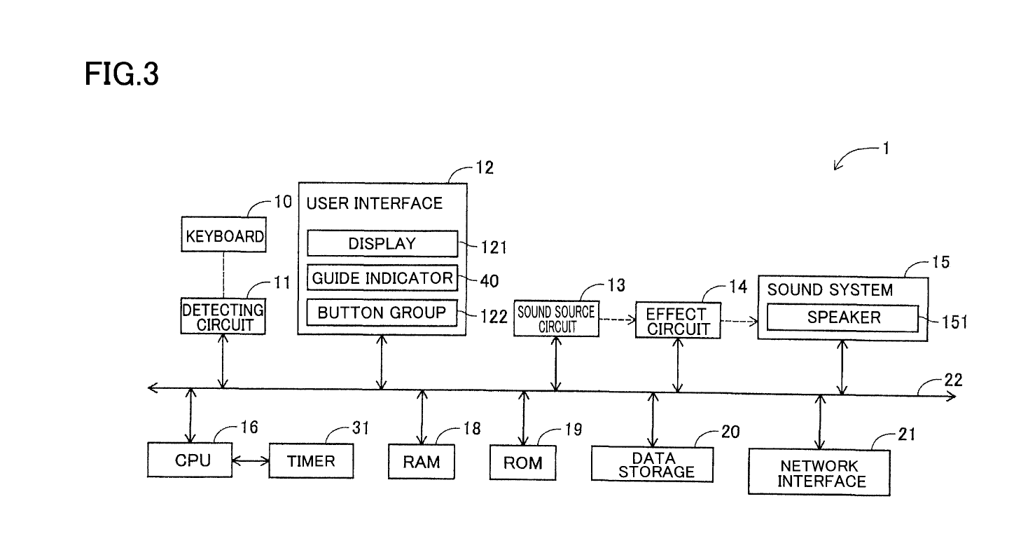

There will be next described an electric configuration of the electronic keyboard instrument 1 with reference to FIG. 3. In addition to the configuration illustrated in FIG. 1, the electronic keyboard instrument 1 includes a detecting circuit 11, a sound source circuit 13, an effect circuit 14, a sound system 15 including the speakers 151, 151, a CPU 16, a timer 31, a RAM 18, a ROM 19, a data storage 20, and a network interface 21. The CPU 16 controls devices by executing various programs stored in the ROM 19. The devices include the detecting circuit 11, the user interface 12, the sound source circuit 13, the network interface 21, and so on connected to the CPU 16 via a bus 22. The RAM 18 is used as a main storage for the CPU 16 to execute various processings. The data storage 20 stores the music data according to MIDI (Musical Instrument Digital Interface, registered trademark), for example. The data storage 20 is a flash memory, for example. The timer 31 counts a length of time to a set time and counts a length of time between events of the music data (which will be described below) in accordance with a command received from the CPU 16, for example. When a remaining time has reached zero, the timer 31 outputs a playing signal, such as a key-pressing signal, to the CPU 16.

The detecting circuit 11 detects motion of the keyboard 10 to create the playing signal (such as the key-pressing signal, a key-releasing signal, and a speed signal) and input the playing signal to the sound source circuit 13 via the CPU 16.

The sound source circuit 13 creates and outputs a digital audio signal in accordance with the playing signal such as the key-pressing signal. The effect circuit 14 outputs a digital audio signal created by adding effects, e.g., reverberation, to the audio signal output from the sound source circuit 13. The sound system 15 includes a digital-to-analog converter, not illustrated, and an amplifier. The digital-to-analog converter converts the digital audio signal output from the effect circuit 14, to an analog audio signal and outputs the analog audio signal to the amplifier. The amplifier amplifies the analog audio signal and outputs the amplified analog audio signal to the speakers 151, 151. The speakers 151, 151 produce sounds in accordance with the input analog audio signal. Thus, the electronic keyboard instrument 1 produces playing sounds in accordance with operations of the keyboard 10. The sound source circuit 13, the effect circuit 14, and the speakers 151, 151 produce automatic playing sounds based on the music data stored in the data storage 20. In the following description, producing the automatic playing sounds may be referred to as “playing”.

The user interface 12 displays information, such as various setting screens, on the liquid crystal display 121 in accordance with the command of the CPU 16, for example. The user interface 12 transmits an operation accepted via an operation button of the button group 122, to the CPU 16 as a signal. The user interface 12 blinks the respective LEDs of the first to third advance lights 41-43 and the key-pressing instructing light 44 individually in accordance with the command of the CPU 16. The network interface 21 performs LAN communication. The CPU 16 can be connected to the Internet via the network interface 21 and a router, not illustrated, to download the music data from a content server that is connected to the Internet to provide the music data.

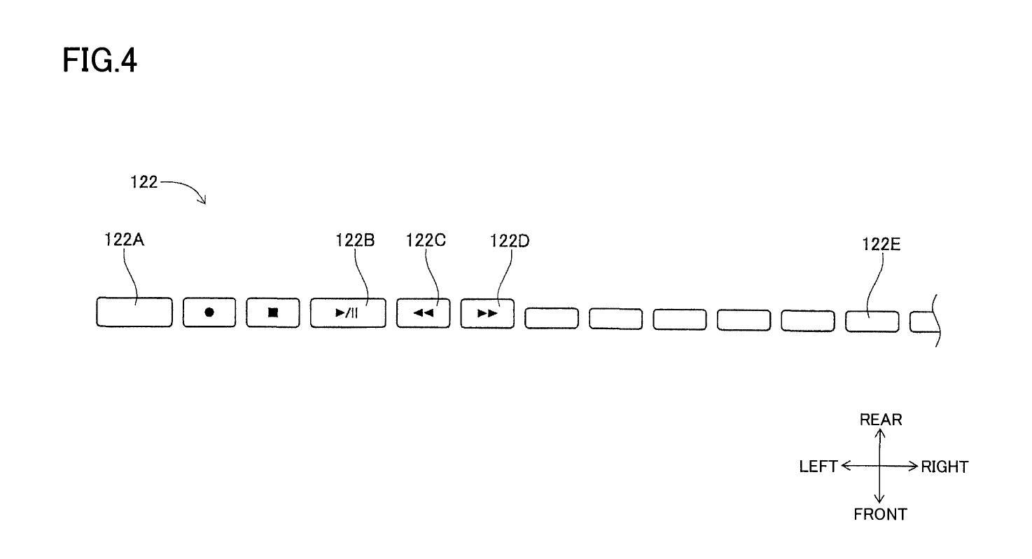

There will be next described the plurality of operation buttons of the button group 122. As illustrated in FIG. 4, the button group 122 includes operation buttons including a song selection button 122A, a start/pause button 122B, a fast reverse button 122C, a fast forward button 122D, and a guide button 122E.

The song selection button 122A is used for the user to select desired music data from among a plurality of the music data stored in the data storage 20. The start/pause button 122B is used when the user instructs the electronic keyboard instrument 1 to start playing based on the music data. The start/pause button 122B is also used when the user instructs the electronic keyboard instrument 1 to start the lesson function (which will be described below). The fast reverse button 122C is used when the user uses fast reverse to search for a play starting position of the music data, for example. The fast forward button 122D is used when the user uses fast forward to search for the play starting position of the music data, for example. The guide button 122E is used when the user performs a setting such that the electronic keyboard instrument 1 performs the lesson function (which will be described below), for example.

### Overview of Lesson Function

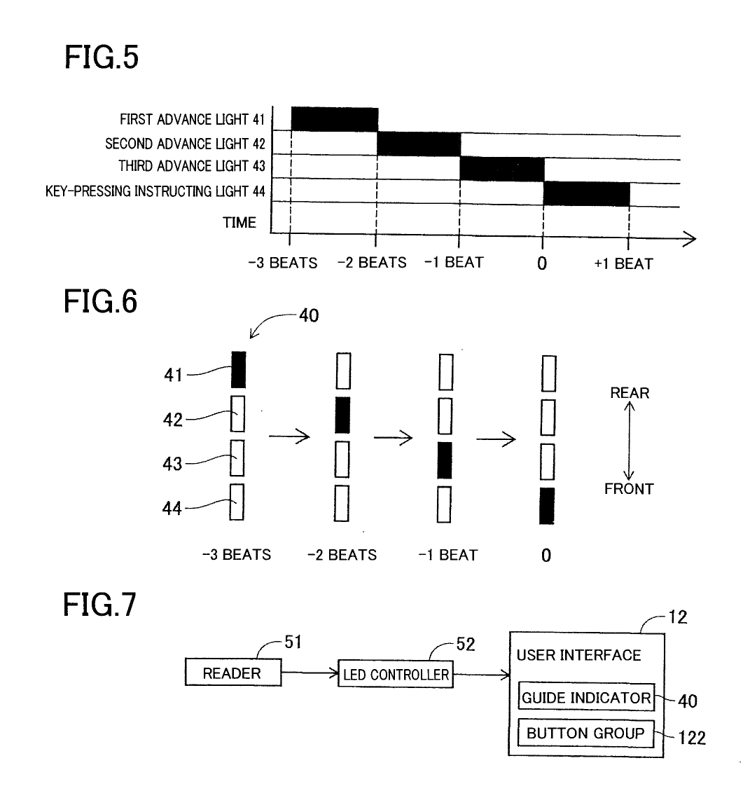

There will be next described the lesson function of the electronic keyboard instrument 1 with reference to one example in FIGS. 5 and 6. In FIGS. 5 and 6, the time is set such that the key pressing timing of a corresponding key is zero. In FIG. 5, a period in which each of the first to third advance lights 41-43 and the key-pressing instructing light 44 illuminates is illustrated in black. In FIG. 6, a period of illumination of each of the first to third advance lights 41-43 and the illuminating key-pressing instructing light 44 is illustrated in black. As illustrated in FIG. 5, when the electronic keyboard instrument 1 starts the lesson function and starts playing the music data, the electronic keyboard instrument 1 turns the first advance light 41 on at the timing earlier than the key pressing timing by three beats. At the timing earlier than the key pressing timing by two beats, the electronic keyboard instrument 1 turns the first advance light 41 off and the second advance light 42 on. At the timing earlier than the key pressing timing by one beat, the electronic keyboard instrument 1 turns the second advance light 42 off and the third advance light 43 on. At the key pressing timing, the electronic keyboard instrument 1 turns the third advance light 43 off and the key-pressing instructing light 44 on. At one beat after the key pressing timing, the electronic keyboard instrument 1 turns the key-pressing instructing light 44 off. As illustrated in FIG. 6, the first to third advance lights 41-43 blink in order as the time passes through the timing earlier than the key pressing timing by the timing three beats, the timing earlier than the key pressing timing by two beats, and the timing earlier than the key pressing timing by one beat. At the key pressing timing, the key-pressing instructing light 44 is turned on. The electronic keyboard instrument 1 performs the above-described blinking for all the guide indicators 40 corresponding to each of the keys of the keyboard 10. By viewing the first to third advance lights 41-43 and the key-pressing instructing light 44 turned on in order, the user can recognizes the keys to be pressed in accordance with the progress of the music in advance of the respective key pressing timings and can press the keys in order. The user can also recognize the key pressing timing by the turning on of the key-pressing instructing light 44.

### Music Data

There will be next described the music data. The music data contains music information and a plurality of tracks. The music information contains information including the music name of the music data. In each of the tracks, data each constituted by a pair of time information and an event are arranged in the order of the progress of a music. The event is data for providing an instruction for a processing. The time information is data indicating the time when the event is to be processed. One of the tracks contains data for lesson, and the other of the tracks contains data for practice. Examples of the event include “note-on” and “note-off” as MIDI events, and “guide-indicator-on” and “guide-indicator-off” as meta events. It is noted that “the guide-indicator-on” and “the guide-indicator-off” are contained in the track for lesson.

The event “note-on” is data for providing an instruction for producing sound, and the event “note-off” is data for providing an instruction for silencing. Each of “note-on” and “note-off” is attached with the note number, the velocity, and so on. The note number is data designating the pitch, and the velocity is data representing the strength of sound. The events “the guide-indicator-on” and “the guide-indicator-off” are data for turning on and off of the guide indicator 40, respectively. Each of the events “the guide-indicator-on” and “the guide-indicator-off” is attached with the note number and so on. In the one example in FIGS. 5 and 6, the time information corresponding to “the guide-indicator-on” is set to a timing that is earlier than a corresponding key pressing timing by three beats. It is noted that the end of the track contains an end code.

### Function Block

There will be next described a function block relating to the lesson function of the electronic keyboard instrument 1 with reference to FIG. 7. In addition to the above-described configuration, the electronic keyboard instrument 1 includes a reader 51 and an LED controller 52. The CPU 16 executes the programs stored in the ROM 19 to achieve the reader 51 and the LED controller 52, for example.

When the user who wants to use the lesson function has operated the song selection button 122A of the button group 122 of the user interface 12 to select desired music data, the CPU 16 reads the selected music data from the data storage 20 and stores the read music data into the RAM 18. The user who wants to start the lesson function presses the start/pause button 122B of the button group 122 after pressing the guide button 122E of the button group 122.

When the reader 51 determines, based on a signal received from the user interface 12, that the start/pause button 122B is pressed, the reader 51 starts a reading processing. Upon the start of the reading processing, the reader 51 sequentially reads sets of the time information and the events from the tracks of the music data stored in the RAM 18 from the first set and uses the timer 31 to output a command related to the event to the LED controller 52 and the sound source circuit 13 at the timing indicated by the time information. In the case where the event is “note-on” or “note-off”, the reader 51 outputs the command “note-on” or “note-off” to the sound source circuit 13. The sound source circuit 13 and the effect circuit 14 execute a signal processing in accordance with the input command “note-on” or “note-off” and the attached note number, velocity, and so on. As a result, the playing sound is emitted from the sound system 15. It is noted that the lesson function is in most cases set such that a sound corresponding to the key for the key pressing timing is excluded from the playing sound, that is, an accompaniment sound is produced. In the present embodiment, however, when the lesson function is started, the sound corresponding to the key for the key pressing timing is played in addition to the accompaniment sound.

In the case where the event is “the guide-indicator-on” or “the guide-indicator-off”, the reader 51 outputs the command “the guide-indicator-on” or “the guide-indicator-off” to the LED controller 52. When the command “the guide-indicator-on” is input, the LED controller 52 starts a switch processing. Upon the start of the switch processing, the LED controller 52 first instructs the user interface 12 to turn on the first advance light 41 of the guide indicator 40 corresponding to the attached note number. Explained with reference to the one example in FIGS. 5 and 6, it is determined using the timer 31 that a time elapsed from the instruction for turning the first advance light 41 on has reached a time equivalent to one beat, the LED controller 52 instructs the user interface 12 to turn off the first advance light 41 of the corresponding guide indicator 40 and turn on the second advance light 42 of the corresponding guide indicator 40. Likewise, when a time elapsed from the instruction for turning the second advance light 42 on has reached the time equivalent to one beat, the LED controller 52 instructs the user interface 12 to turn off the second advance light 42 of the corresponding guide indicator 40 and turn on the third advance light 43 of the corresponding guide indicator 40. Likewise, a time elapsed from the instruction for turning the third advance light 43 on has reached the time equivalent to one beat, the LED controller 52 instructs the user interface 12 to turn off the third advance light 43 of the corresponding guide indicator 40 and turn on the key-pressing instructing light 44 of the corresponding guide indicator 40. When the command “the guide-indicator-off” is then input, the LED controller 52 instructs the user interface 12 to turn the key-pressing instructing light 44 off and terminates the switch processing. In the switch processing, turning on and turning off of the first to third advance lights 41-43 and the key-pressing instructing light 44 are switched at intervals of one beat.

It is noted that when the reader 51 determines that the start/pause button 122B is operated, the reader 51 temporarily stops the reading processing, and when the reader 51 has read the end code of the music data, the reader 51 terminates the reading processing.

### Play Start Mode

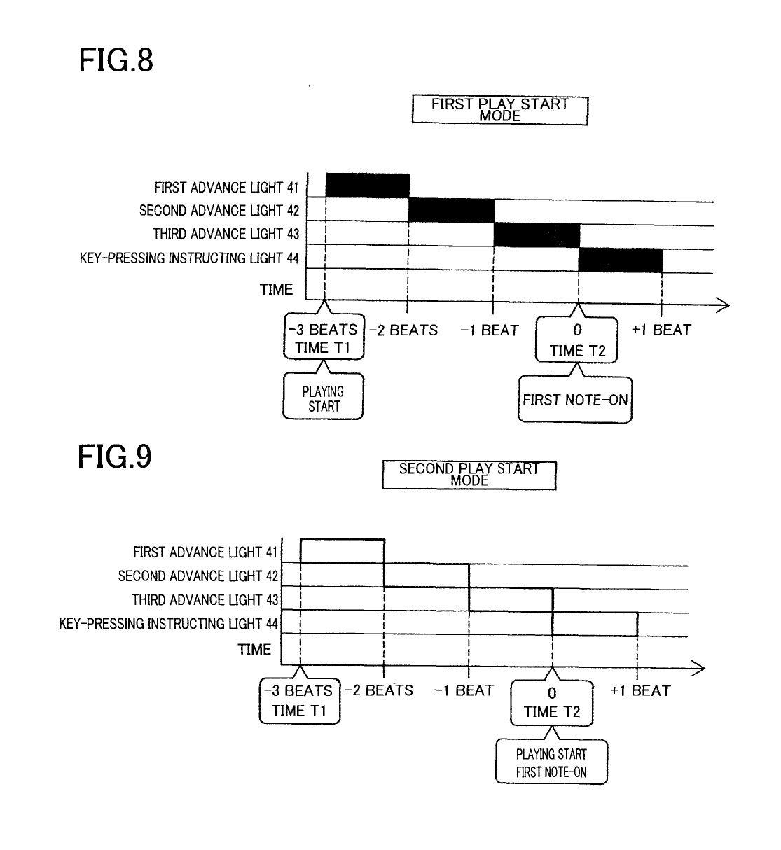

Modes of the electronic keyboard instrument 1 for starting playing based on the music data include a first play start mode and a second play start mode. There will be described the first play start mode and the second play start mode with reference to FIGS. 8 and 9. The following description will be provided assuming a case where the key-pressing advance notice and the key-pressing instruction illustrated in FIG. 5 are set to be performed for the key to be pressed first in the music data to be played. It is noted that there are two cases of playing based on the music data: a case where the music data is played from its beginning; and a case where the music data is played from its midpoint. The electronic keyboard instrument 1 may be set such that the sound corresponding to the key pressed by the user is produced during playing based on the music data based on the playing signal received from the detecting circuit 11 or not produced during playing based on the music data.

### First Play Start Mode

There will be first described the first play start mode of the electronic keyboard instrument 1 with reference to FIG. 8. In FIG. 8, a playing instruction is provided such that a first “note-on” command is issued at zero as the first key pressing timing in playing based on the music data. That is, the time that is earlier than zero as the first key pressing timing by three beats is set to first time T1, and zero as the first key pressing timing is set to second time T2. That is, the turning-on timing (the first turning-on timing) of the first advance light 41 of the guide indicator 40 corresponding to the key for the first key pressing timing is set to first time T1, and the turning-on timing (the last turning-on timing) of the key-pressing instructing light 44 of the guide indicator 40 corresponding to the key for the first key pressing timing is set to second time T2. Here, in the first play start mode in FIG. 8, an instruction for playing based on performance information is provided at time T1 or the timing that is earlier than time T1 by a predetermined period.

It is noted that these settings are applied also in FIG. 9 that is used for explanation of the second play start mode (which will be described below). In the second play start mode in FIG. 9, an instruction for playing based on the music data is provided at time T2 or the timing that is earlier than time T2 by a predetermined period.

In the first play start mode, as illustrated in FIG. 8, playing based on the music data is started at first time T1. At second time T2 that is later than first time T1 by three beats, a MIDI event storing the first “note-on” is processed. That is, a sound corresponding to the key for the first key pressing timing is produced at second time T2 in playing based on the music data. That is, second time T2 is a timing at which the sound corresponding to the key to be pressed first is produced. Accordingly, in the case where the playing based on the music data is started in the first play start mode, the time for the key-pressing advance notices given by the first to third advance lights 41-43 and the time of the key-pressing instruction provided by the key-pressing instructing light 44 are ensured in the guide indicator 40 corresponding to the key for the first key pressing timing in the playing. In other words, when the instruction for playing based on the performance information is provided at the timing that is earlier than first time T1 by a predetermined period, the sound corresponding to the key to be pressed first is produced at second time T2, for example.

It is noted that FIG. 8 illustrates the case where the key-pressing advance notice and the key-pressing instruction are provided when playing based on the music data is started in the first play start mode, and a period of illumination of each of the first to third advance lights 41-43 and the key-pressing instructing light 44 of the guide indicator 40 corresponding to the key for the first key pressing timing in the playing is illustrated in black in FIG. 8.

### Second Play Start Mode

There will be next described the second play start mode of the electronic keyboard instrument 1 with reference to FIG. 9. In the second play start mode, as illustrated in FIG. 9, playing based on the music data is not started at first time T1, and playing based on the music data is started, and the MIDI event storing the first “note-on” is processed at second time T2. That is, the sound corresponding to the key for the first key pressing timing is produced at second time T2 concurrently with the start of playing based on the music data. Accordingly, in the case where playing based on the music data is started in the second play start mode, the time for the key-pressing advance notices given by the first to third advance lights 41-43 is not ensured in the guide indicator 40 corresponding to the key for the first key pressing timing in the playing. In other words, when the instruction for playing based on the music data is provided at the timing earlier than the second time T2 by a predetermined period, the sound corresponding to the key to be pressed first is produced at second time T2, for example. The time of the key-pressing instruction provided by the key-pressing instructing light 44 is ensured.

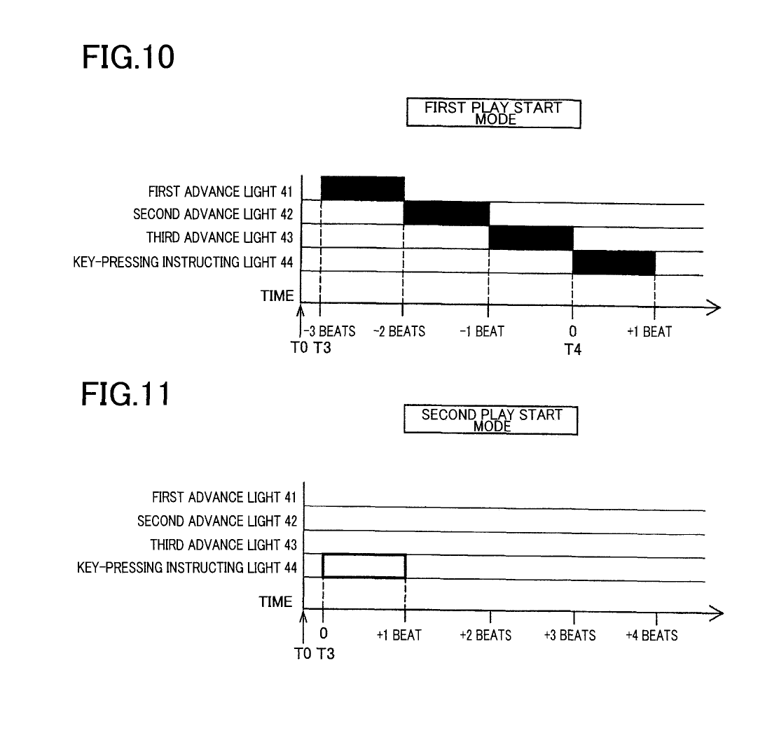

It is noted that FIG. 9 illustrates the case where the key-pressing advance notice and the key-pressing instruction are provided when playing based on the music data is started in the second play start mode, and a white portion in FIG. 9 represents a set period in which each of the first to third advance lights 41-43 and the key-pressing instructing light 44 of the guide indicators 40 corresponding to the key for the first key pressing timing in the playing should be turned on. In the second play start mode, as described above, when an instruction for playing based on the music data is provided, the sound corresponding to the first “note-on” key is produced without waiting for a period in which each of the first to third advance lights 41-43 is turned on as the period of the key-pressing advance notice as in the first play start mode. This will be explained below. FIGS. 10 and 11 respectively correspond to FIGS. 8 and 9 and respectively explain the first play start mode and the second play start mode. It is noted that FIG. 11 illustrates the case where the key-pressing instruction is assumed when playing based on the music data is started in the second play start mode, and a white portion in FIG. 11 represents a set period in which the key-pressing instructing light 44 corresponding to the key for the first key pressing timing in the playing. In FIGS. 10 and 11, time T0 on the time axis as the horizontal axis represents the time point when an instruction for starting playing based on the music data is provided. Time T0, for example, is the time point when the start/pause button 122B is used by the user to instruct the electronic keyboard instrument 1 to perform playing based on the music data (i.e., the time point when the playing instruction is provided). In the first play start mode, as illustrated in FIG. 10, after the instruction for playing based on the music data is provided at time T0, playing based on the music data is started at third time T3 (as one example of a first time point). In this operation, the first advance light 41 is turned on. At time T4 (as one example of a second time point) that is later than third time T3 by three beats, production of the sound corresponding to the first “note-on” key is started. In this operation, the key-pressing instructing light 44 is turned on. That is, a period required from the time point (time T0) at which the playing instruction is provided, to the start of production of the sound corresponding to the first “note-on” key is “T4-T0”. In the second play start mode, as illustrated in FIG. 11, after the instruction for playing based on the music data is provided at time T0, the playing based on the music data is started at third time T3, and production of the sound corresponding to the first “note-on” key is started at third time T3 (as another example of the second time point). That is, a period required from the time point (time T0) at which the playing instruction is provided, to the start of production of the sound corresponding to the first “note-on” key is “T3-T0”. When compared with the required period in the first play start mode, the required period in the second play start mode is less than the required period in the first play start mode by a time equivalent to three beats. That is, a period from the playing instruction to the start of production of the sound corresponding to the first “note-on” key is less in the second play start mode than in the first play start mode by a period required for the key-pressing advance notice (a period equivalent to three beats). Thus, the period of the key-pressing advance notice is removed in the second play start mode, enabling quick start of the playing.

### Playing Based on Music Data

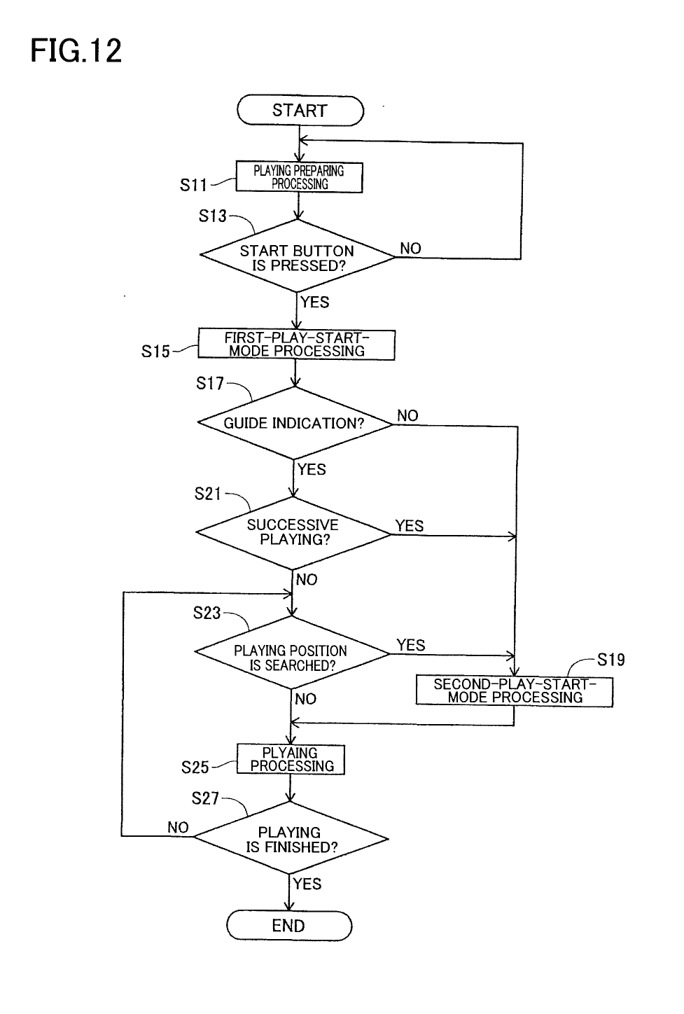

There will be next described playing based on the music data in the electronic keyboard instrument 1 with reference to FIG. 12. The program represented by the flowchart in FIG. 12 is, for example, stored in the ROM 19 and implemented by being executed by the CPU 16.

In playing based on the music data by the electronic keyboard instrument 1, as illustrated in FIG. 12, the CPU 16 executes a playing preparing processing (S11). In the playing preparing processing (S11), the user operates the user interface 12 to select the music data to be played. Specifically, when the song selection button 122A is pressed by the user, for example, the liquid crystal display 121 displays the music names of a plurality of the music data stored in the data storage 20. The user operates an operation button of the button group 122, for example, to select a desired music name for playing from among the music names displayed on the liquid crystal display 121. As a result, the music data to be played is selected. It is noted that one or two or more music data can be selected in this selecting operation.

In the playing preparing processing (S11), the user can press the guide button 122E of the user interface 12 to set the electronic keyboard instrument 1 such that the electronic keyboard instrument 1 uses the lesson function to perform playing based on the music data.

In the playing preparing processing (S11), the user can press the start/pause button 122B of the user interface 12 to cause the electronic keyboard instrument 1 to start playing based on the music data.

The CPU 16 determines whether the start/pause button 122B is pressed (S13). This determination is executed based on a signal received from the user interface 12. Here, when the start/pause button 122B is not pressed (S13: NO), the playing preparing processing (S11) is continued. When the start/pause button 122B is pressed (S13: YES), the CPU 16 executes a first-play start mode processing (S15). In this processing, the electronic keyboard instrument 1 is set such that the music data is played in the first play start mode.

The CPU 16 determines whether the electronic keyboard instrument 1 is set such that the music data is played by operation of the guide indicator 40, i.e., the lesson function (S17). This determination is executed based on whether the guide button 122E is pressed, i.e., based on the signal received from the user interface 12.

Here, when the electronic keyboard instrument 1 is set such that the guide indicator 40 is not to be operated, that is, when the guide button 122E is not pressed (S17: NO), the CPU 16 executes a second-play start mode processing (S19). In this processing, the setting of the first play start mode (S15) is changed, and the electronic keyboard instrument 1 is set such that the music data is played in the second play start mode. The CPU 16 then executes a processing at S25 (which will be described below). Specifically, as illustrated in FIG. 11, in the case where an instruction for playing based on the music data is provided at time T0, that is, in the case where the instruction for playing based on the music data is provided by pressing of the start/pause button 122B, production of the sound corresponding to the first “note-on” key for the music data is started at third time T3 in response to the playing instruction to start playing based on the music data. When the electronic keyboard instrument 1 is set such that the guide indicator 40 is to be operated, that is, when the guide button 122E is pressed (S17: YES), the CPU 16 determines whether the electronic keyboard instrument 1 is set such that successive playing is to be performed. This determination is executed based on whether two or more music data are selected in the playing preparing processing (S11).

It is noted that the successive playing is an operation in which two or more music data selected in the playing preparing processing (S11) are sequentially played. That is, in the successive playing, when playing based on the music data is finished, playing based on the next music data is started.

Here, when the electronic keyboard instrument 1 is set such that successive playing is to be performed, that is, when two or more music data are selected in the playing preparing processing (S11) (S21: YES), the CPU 16 executes the second-play start mode processing (S19). The CPU 16 then executes the processing at S25 (which will be described below). Specifically, as illustrated in FIG. 11, in the case where playing based on the music data played previously is finished, and an instruction for playing based on the music data to be played next is provided at time T0, production of a sound corresponding to the first “note-on” key for the next music data is started at third time T3 in response to this playing instruction to start playing the next music data. When the electronic keyboard instrument 1 is set such that successive playing is not to be performed, that is, when one music data is selected in the playing preparing processing (S11) (S21: NO), the CPU 16 determines whether a playing position is searched (S23). This determination is executed based on whether the fast reverse button 122C or the fast forward button 122D of the user interface 12 is pressed, i.e., based on a signal received from the user interface 12.

Here, when the playing position is searched, that is, when the fast reverse button 122C or the fast forward button 122D is pressed (S23: YES), the CPU 16 executes the second-play start mode processing (S19). The CPU 16 then executes the processing at S25 (which will be described below). Specifically, when the fast reverse button 122C or the fast forward button 122D is pressed during playing based on the music data, the playing based on the music data is suspended, and the restart position is set by the fast reverse button 122C or the fast forward button 122D to a position different from a position at which the playing based on the music data is suspended. As illustrated in FIG. 11, when an instruction for starting playing based on the music data from the restart position is provided at time T0, production of a sound corresponding to the first “note-on” key on or after the restart position of the music data (a key to be pressed first on or after the play starting position) is started at third time T3 in response to this playing instruction to restart playing based on the music data.

When the playing position is not searched, that is, when the fast reverse button 122C or the fast forward button 122D is not pressed (S23: NO), the CPU 16 executes a playing processing (S25). It is noted that the playing processing (S25) is executed also after the second-play start mode processing (S19) is executed.

In the playing processing (S25), the music data selected in the playing preparing processing (S11) is played. It is noted that when two or more music data are selected (S21: YES), the two or more music data are played successively. Here, when the setting of the first play start mode (S15) is kept, playing based on the music data is started in the first play start mode. When the setting is changed from the first play start mode (S15) to the second play start mode (S19), playing based on the music data is started in the second play start mode.

In the present embodiment, in the case where playing based on the music data is started in the first play start mode, the guide indicators 40 are set to be operated (S17: YES), and thus the start of playing based on the music data in the first play start mode and playing based on the music data after the start are performed by implementing the lesson function, for example.

In the case where playing based on the music data is started in the second play start mode, when the guide indicators 40 are set not to be operated (S17: NO), the start of playing based on the music data in the second play start mode and playing based on the music data after the start are performed by implementing the lesson function while treating the music data as not containing tracks for lesson, for example. When the guide indicators 40 are set to be operated (S17: YES), and when the electronic keyboard instrument 1 is set such that successive playing is to be performed (S21: YES), or the playing position is searched (S23: YES), playing based on the music data is started in the second play start mode. Here, the start of playing based on the music data in the second play start mode and playing based on the music data after the start are performed by implementing the lesson function while considering that there is no meta event corresponding to the MIDI event storing the first “note-on”, for example. That is, the lesson function is implemented by utilizing tracks for lesson in the music data, in playing based on the music data on or after production of sound for the first “note-on” key in the second play start mode.

The CPU 16 thereafter determines whether playing is to be finished (S26). This determination is performed based on whether the end code of the music data being played is read, for example. It is noted that, when two or more music data are selected (S21: YES), this determination is executed based on whether the end code of the last music data being played is read, for example. Here, when playing is not to be finished (S27: NO), the processing at S23 is repeated. Accordingly, playing based on the music data is started in the first play start mode, and the fast reverse button 122C or the fast forward button 122D is pressed in playing based on the music data, whereby when the playing position of the music data is searched (S23: YES), playing based on the music data which starts from the playing position is performed in the second play start mode (S19, S25). When the playing position of the music data being played is not searched (S23: NO), the playing based on the music data is kept (S25).

It is noted that when playing is finished (S27: YES), the CPU 16 terminates this program.

### SUMMARY

As described above in detail, the electronic keyboard instrument 1 according to the present embodiment includes: the keyboard 10 including the white keys 10a and the black keys 10b; and a plurality of the guide indicators 40 provided corresponding to the respective keys of the keyboard 10. In each of the guide indicators 40, the first to third advance lights 41-43 and the key-pressing instructing light 44 are arranged in a line along the front and rear direction of the key corresponding to the guide indicator 40. In the electronic keyboard instrument 1 according to the present embodiment, playing based on the music data is started (S25) in the first play start mode (S15) or the second play start mode (S19) by the CPU 16 executing the program represented by the flowchart in FIG. 10.

In the first play start mode, as illustrated in FIG. 8, playing based on the music data is started at first time T1 at which the first advance light 41 with the largest distance from the key in the guide indicator 40 corresponding to the key to be pressed first in the playing based on the music data is turned on in advance of the timing at which the key is to be pressed (time 0). At second time T2 at which the key-pressing instructing light 44 with the smallest distance from the key to be pressed first in the playing based on the music data is turned on at the timing at which the key is to be pressed (time 0), the sound corresponding to the key is produced (the first “note-on”). In the second play start mode, in contrast, as illustrated in FIG. 9, the sound corresponding to the key to be pressed first in the music data is produced (the first “note-on”) concurrently with the start of playing based on the music data at second time T2.

Accordingly, in the first play start mode, the time for the key-pressing advance notices given by the first to third advance lights 41-43 is ensured for the guide indicator 40 corresponding to the key to be pressed first in playing based on the music data. In the second play start mode, in contrast, the time for the key-pressing advance notices given by the first to third advance lights 41-43 is not ensured for the guide indicator 40 corresponding to the key to be pressed first in playing based on the music data. Thus, the electronic keyboard instrument 1 according to the present embodiment has: the first play start mode in which the time for the key-pressing advance notice is ensured at the start of playing based on the music data; and the second play start mode in which the time for the key-pressing advance notice is removed at the start of playing based on the music data.

In the electronic keyboard instrument 1 according to the present embodiment, in the case where the electronic keyboard instrument 1 is set such that the guide indicator 40 is not operated (S17: NO), in the case where the electronic keyboard instrument 1 is set such that successive playing is to be performed (S21: YES) or in the case where the playing position is searched (S23: YES), the setting of the first play start mode (S15) is changed, and the electronic keyboard instrument 1 is set such that the music data is played in the second play start mode (S19). This enables the electronic keyboard instrument 1 according to the present embodiment to automatically switch the mode of the start of playing based on the music data from the first play start mode to the second play start mode in response to establishment of any of the above-described three cases.

When the user has pressed the start/pause button 122B without pressing the guide button 122E, the guide indicator 40 is set not to be operated. In this case (S17: NO), the user does not desire operation of the guide indicators 40. Accordingly, removal of the time for the key-pressing advance notice at the start of playing based on the music data in this case by automatically switching the mode of the start of playing based on the music data from the first play start mode to the second play start mode meets user's purpose and is useful for the user.

When the electronic keyboard instrument 1 is set by the user having pressed the song selection button 122A such that successive playing is to be performed, for example (S21: YES), it is considered that the user in most cases desires to listen a plurality of music data played successively as a listener. Accordingly, removal of the time for the key-pressing advance notice at the start of playing based on the music data in this case by automatically switching the mode of the start of playing based on the music data from the first play start mode to the second play start mode meets user's purpose and is useful for the user.

When the playing position is searched by the user having pressed the fast reverse button 122C or the fast forward button 122D, for example (S23: YES), it is considered that the user in most cases desires as a listener to listen music data for which playing is restarted after a search using the fast reverse operation and the fast forward operation. Accordingly, removal of the time for the key-pressing advance notice at the start of playing based on the music data in this case by automatically switching the mode of the start of playing based on the music data from the first play start mode to the second play start mode meets user's purpose and is useful for the user.

In the present embodiment, the electronic keyboard instrument 1 is one example of a keyboard instrument. The white keys 10a and the black keys 10b are one example of a plurality of keys. The front and rear direction is one example of the longitudinal direction of the key. The first to third advance lights 41-43 and the key-pressing instructing light 44 are one example of a plurality of guide lamps. The first advance light 41 is one example of a guide lamp farthest from the keyboard. The key-pressing instructing light 44 is one example of a guide lamp nearest to the keyboard. The key pressed at the first key pressing timing in playing based on the music data is one example of a key to be operated first. The CPU 16, the timer 31, the sound source circuit 13, the effect circuit 14, the speakers 151, 151, and so on are one example of a playing device. First time T1 is one example of a first time point. Second time T2 is one example of a second time point. The time 0 is one example of a timing at which the key is to be pressed. Third time T3 is another example of the first time point or the second time point, and fourth time T4 is yet another example of the second time point. The music data is one example of performance information.

### Others

It is noted that the present disclosure is not limited to the above-described embodiment, but may be embodied with various changes without departing from the spirit and scope of the disclosure. For example, the setting of the first play start mode (S15) may be kept even when the electronic keyboard instrument 1 is set such that the guide indicator 40 is not operated (S17: NO), when the electronic keyboard instrument 1 is set such that successive playing is to be performed (S21: YES), or when the playing position is searched (S23: YES). In such a case, switching from the first play start mode to the second play start mode is performed by the user operating the user interface 12.

In the present embodiment, the start of playing based on the music data in the second play start mode and playing based on the music data after the start are performed by implementing the lesson function while treating the music data as not containing tracks for lesson, for example. In such a case, when playing based on the music data is started in the second play start mode, the key-pressing advance notices by the respective first to third advance lights 41-43 and the key-pressing instruction by the key-pressing instructing light 44 are not provided at any key pressing timing. In the second play start mode, however, the time of the key-pressing instruction provided by the key-pressing instructing light 44 is ensured at any key pressing timing, and accordingly the key-pressing instruction may be provided by the key-pressing instructing light 44.

Even in the case where playing based on the music data is started in the second play start mode, the key-pressing advance notices may be given by the respective first to third advance lights 41-43. In the case where this case is applied to the example in FIG. 9, the key-pressing advance notice is given for the key corresponding to the first key pressing timing (time 0), but the key-pressing advance notice is given by the third advance light 43 for the key corresponding to the key pressing timing that is later than the first key pressing timing by one beat (time 0). The key-pressing advance notices are given by the second advance light 42 and the third advance light 43 for the key corresponding to the key pressing timing that is later than the first key pressing timing (time 0) by two beats. The key-pressing advance notices are given by the first advance light 41, the second advance light 42, and the third advance light 43 for the keys corresponding to the key pressing timing that is later than the first key pressing timing (time 0) by three beats and corresponding to timings after the key pressing timing.

In the present embodiment, when the music data is played using the lesson function, the sound corresponding to the key for the key pressing timing is produced in addition to accompaniment sounds, regardless of whether the mode for starting the playing is any of the first play start mode and the second play start mode. However, music data may be configured such that the sound corresponding to the key for the key pressing timing is produced, but accompaniment sounds are not produced in playing based on the music data.

In the present embodiment, the advance lights for giving the key-pressing advance notices are constituted by the first advance light 41, the second advance light 42, and the third advance light 43, but the present disclosure is not limited to this configuration. For example, the advance lights for giving the key-pressing advance notices may be constituted by the second advance light 42 and the third advance light 43. In the case where such a configuration is applied to the example in FIG. 8, first time T1 in the first play start mode is set to a timing that is earlier than the first key pressing timing (time 0) by two beats. The advance light for giving the key-pressing advance notice may be constituted by the third advance light 43. In the case where such a configuration is applied to the example in FIG. 8, first time T1 in the first play start mode is set to a timing earlier than the first key pressing timing (time 0) by one beat. It is noted that the advance lights for giving the key-pressing advance notices may be constituted by not only the first advance light 41, the second advance light 42, and the third advance light 43 but also another or other advance lights.

While the electronic keyboard instrument 1 is taken as one example of the keyboard instrument in the present embodiment, the present disclosure is not limited to this configuration. Since the guide indicators 40 are controlled independently of the sound related to the key as described above, the present disclosure may be applied to acoustic keyboard instruments such as acoustic pianos, for example.

While the LEDs are provided respectively for the first to third advance lights 41-43 and the key-pressing instructing light 44 constituting the plurality of guide lamps in the present embodiment, the present disclosure is not limited to this configuration. For example, fluorescent lights may be provided respectively for the first to third advance lights 41-43 and the key-pressing instructing light 44.

While “the guide-indicator-on” and “the guide-indicator-off” are contained in the music data in advance in the present embodiment, the present disclosure is not limited to this configuration. One or both of “the guide-indicator-on” and “the guide-indicator-off” may not be contained in the music data. In the case where this configuration is applied to the example in FIG. 5, when “the guide-indicator-on” is not contained in the music data, the reader 51 reads the time information and the event substantially at the same time, reads data “note-on”, and outputs a “note-on” command to the LED controller 52 at a timing corresponding to the timing earlier than time information corresponding to the “note-on” command by three beats, and in response the LED controller 52 turns the first advance light 41 on, for example.

What is claimed is:

1. A keyboard instrument, comprising:
a keyboard comprising a plurality of keys;
a plurality of guide lamps provided corresponding respectively to the plurality of keys of the keyboard and arranged in a longitudinal direction of the plurality of keys; and
a playing device configured to start playing based on performance information in a first play start mode or a second play start mode,
wherein, in the first play start mode, in response to a playing instruction that is an instruction for playing based on the performance information, a guide lamp farthest from the keyboard among the plurality of guide lamps for a key to be operated first among the plurality of keys is turned on at a first time point that is earlier than a timing at which a sound corresponding to the key to be operated first is output, and a guide lamp nearest to the keyboard among the plurality of guide lamps is turned on at a second time point that is a timing at which the key to be operated first is to be pressed, and the sound corresponding to the key to be operated first is output at the second time point, and
wherein, in the second play start mode, in response to the playing instruction, the sound corresponding to the key to be operated first is output at the second time point.

2. The keyboard instrument according to claim 1, wherein the playing device is configured to: start playing based on the performance information in the second play start mode when a predetermined condition is satisfied; and start playing based on the performance information in the first play start mode when the predetermined condition is not satisfied.

3. The keyboard instrument according to claim 2, wherein the predetermined condition is a condition that a setting in which the plurality of guide lamps are not turned on is made.

4. The keyboard instrument according to claim 2, wherein the predetermined condition is a condition that a setting in which a plurality of pieces of performance information are to be played successively is made.

5. The keyboard instrument according to claim 2, wherein the predetermined condition is a condition that a setting in which a position of a sound to be produced first in the performance information is to be searched is made.

6. A keyboard instrument, comprising:
a keyboard comprising a plurality of keys;
a plurality of guide lamps provided corresponding respectively to the plurality of keys of the keyboard and arranged in a longitudinal direction of the plurality of keys; and
a playing device configured to start playing based on the performance information,
wherein the playing device is configured to:
when the predetermined condition is satisfied, in response to a playing instruction that is an instruction for playing based on the performance information, output a sound corresponding to a key to be operated first among the plurality of keys, at a time point at which a first period has elapsed from the playing instruction; and
when the predetermined condition is not satisfied, in response to the playing instruction, turn on the plurality of guide lamps in order from a guide lamp farthest from the keyboard, to a guide lamp nearest to the keyboard among the plurality of guide lamps for the key to be operated first, and output the sound corresponding to the key to be operated first, at a time point at which a second period greater than the first period has elapsed from the playing instruction.

7. The keyboard instrument according to claim 6,
wherein the predetermined condition is a condition that a setting in which the plurality of guide lamps are not turned on is made, and
wherein the playing instruction is an instruction for starting playing based on the performance information.

8. The keyboard instrument according to claim 6,
wherein the predetermined condition is a condition that a setting in which a plurality of pieces of performance information are to be played successively is made, and
wherein the playing instruction is an instruction for starting playing based on performance information to be played next, based on an end of playing based on performance information previously played among the plurality of pieces of performance information.

9. The keyboard instrument according to claim 6,
wherein the predetermined condition is a condition that playing based on the performance information is suspended during the playing, and the playing based on the performance information is performed at a position different from a position at which the playing is suspended, and
wherein the playing instruction is an instruction for playing based on the performance information from the different position.
